(19) United States
(12) Patent Application Publication
(10) Pub. No.: US 2007/0162455 A1
(43) Pub. Date: Jul. 12, 2007

(54) System for and method of gathering complex structured information

(76) Inventor: Walter Oney, Boston, MA (US)

Correspondence Address: BURNS & LEVINSON, LLP, 125 SUMMER STREET, BOSTON, MA, 02110, US

(21) Appl. No.: 11/322,979

(22) Filed: Dec. 30, 2005

(51) Int. Cl. G06F 17/30

(52) U.S. Cl. 707/10

(57) ABSTRACT

A system, method and computer program product for gathering complex structured information in an automated manner is disclosed, which may be substituted for an in-person interview between a trained professional interviewer possessing complex domain knowledge and an untrained consumer of professional services. The method involves sequential downloads of encrypted smart forms from a server to a consumer's computer, presentation of forms with contents tailored to the needs of the consumer as deduced from the consumer's responses to previous forms, validation and interpretation of the consumer's responses based on domain-specific and common-sense rules, a segregation of the consumer's responses into pieces requiring varying degrees of confidential or expedited handling, and an encrypted upload of the resulting information to a server.

### COPYRIGHT NOTICE

A portion of the disclosure of this patent document contains material which is subject to copyright protection. The copyright owner has no objection to the facsimile reproduction by anyone of the patent document or the patent disclosure as it appears in the Patent and Trademark Office patent file or records but otherwise reserves all copyright rights whatsoever.

### FIELD OF THE INVENTION

The present invention relates to gathering the information appropriate to a professional consultation using a computer and, more particularly, to conducting an automated interview by means of smart forms downloaded from a server.

### BACKGROUND OF THE INVENTION

An interview between a trained professional and a consumer of professional services is often a required prelude to the initiation of a professional consultation. For example, an attorney typically gathers a great deal of specialized information involving names of parties and witnesses, time and place of occurrences, and so on, from a prospective client prior to establishing an attorney-client relationship. A financial advisor typically gathers specialized information involving assets, liabilities and goals prior to rendering planning advice. A physician typically gathers a medical history and a statement of the complaint with which a new patient presents prior to initiating treatment.

Professional knowledge is needed to ask the right questions. For example, a prospective legal client might state that he is having problems with credit, which may lead the lawyer to explain the advantages and disadvantages of bankruptcy. A prospective financial client may indicate that all her children are grown and living on their own, which may lead the adviser to omit questions about saving for college tuition. A static questionnaire covering all possible questions that a professional might need to ask a prospective client would be impractically large and confusing.

Traditional face-to-face interviews in a professional office do not provide an optimal setting for the gathering of all necessary information. In all such situations, the professional interviewer must spend significant time asking questions and recording answers. Lack of client preparation may render an initial interview unproductive. Lack of adequate instructions about what to bring to the interview may cause the client to waste a trip to the professional's office. In a law-office setting, disclosures about adverse parties may create a conflict of interest for the attorney after the attorney has already learned confidential information, thereby damaging a pre-existing relationship. In a medical setting, a patient might not correctly prioritize symptoms, with the result that acute care might not be prescribed in a timely manner.

Existing methods for gathering information over the Internet rely on the use of scripts imbedded into hypertext markup language (HTML) forms. Existing technology permits only a small amount of information to be stored on an end-user's computer in the form of a “cookie.” In order to conduct an interview involving complex structured information, therefore, existing web-based applications necessarily transmit information, including sensitive personal information, from the end-user's computer to a server computer, where such information is processed by software to generate additional HTML forms. Not only does this method compromise the security of sensitive personal information, but it also results in a very slow interaction.

What is needed, then, is an interviewing tool that automates the collection of information from an end-user using a client computer without requiring the transmission of sensitive personal information back to a server or the performance of computations on the server to tailor the information in successive forms.

### SUMMARY OF THE INVENTION

According to the present invention, the above-described and other objects are accomplished by providing a system, method and computer program product for gathering complex structured information from a user of a client computer, preferably over a network such as, for example, the Internet. A system in accordance with the invention includes a server operatively coupled to a repository of a collection of “smart” electronic forms each comprising a display component that when parsed by the client computer instructs the client computer how to render text and input fields on a display device (e.g., a screen) operatively coupled to the client computer, and an executable component that includes logic for validating captured user input field data and logic for applying domain knowledge to user response data. The system also includes a smart form server application executing on the server and including logic for transmitting one or more of the smart forms from the repository to the client computer in response to form requests sent by a client application executing on the client computer. The client application includes logic for requesting one or more of the smart forms, for parsing the display component and for running the executable component of the one or more transmitted forms so as to gather response data from the user by rendering on the display device text and input fields associated with the transmitted form(s), capturing field data input by the user in response to the rendered text and input fields and by validating the input field data. If the validation reveals an input field data error, the client application calls for reentry of the input field data, with or without modifications to the text and input fields when re-rendered on the display device for the user. The client application determines whether additional actions may be necessary by applying domain-based knowledge to the gathered response data, initiates the additional actions that may be deemed necessary, and transmits the gathered user response data from the client computer to another computer such as, for example, the server.

The additional action resulting from the application of the domain-based knowledge could, for example, comprise requesting an additional smart form or forms from the collection and a return to the display component parsing and executable component running steps, or could comprise providing a selected portion of the gathered response data to a party at the other computer, such as providing a list of potential adverse parties that could be screened for conflicts by an attorney before reviewing any privileged or confidential information potentially compromising the user's legal position. The determination of possible additional action(s) needed may be based at least in part on response data previously gathered utilizing prior smart forms in an interview script.

The client computer on which the client application executes and the server on which the smart form server application executes are preferably connected by a network connection, such as the public Internet, and data transmissions between the client computer and the server may be encrypted.

In preferred embodiments of the invention, the display component of each smart form comprises instructions represented by code in a nonstandard version of the hypertext markup language that includes one or more of the following HTML-compatible tags: tags for repeating text or fields; tags for conditionally displaying text or fields; tags for conditionally displaying error messages; and/or tags for populating a list of choices from a list not part of the hypertext markup language source code. In these and/or other embodiments, the executable component of each smart form is comprised of a binary object file containing external references to locations in the client application and in the executable components of other smart forms.

In another, further aspect of the invention, information gathered by the client application is transmitted in encrypted form to another computer in two or more parts, one part comprised of unprivileged or nonconfidential information and the other part or parts comprised of privileged or confidential information that should not be read until after inspection of the unprivileged or nonconfidential information.

### BRIEF DESCRIPTION OF THE FIGURES

The above and other objects, features and advantages of the invention will become apparent from a consideration of the subsequent detailed description presented in connection with accompanying drawings, in which:

FIG. 1 is a screen shot of a display device depicting an exemplary rendering of text and input fields in accordance with an embodiment of the present invention;

FIG. 2 is block diagram showing a system according to the present invention for gathering complex structured information over the Internet;

FIG. 3 is a block diagram showing the transfer of encrypted commands and answers within a system in accordance with an embodiment of the present invention;

FIG. 4 illustrates the composition of a smart form as comprising a display component and an executable component; and

FIG. 5 is a flow diagram illustrating a method performed by the client computer in accordance with an embodiment of the present invention.

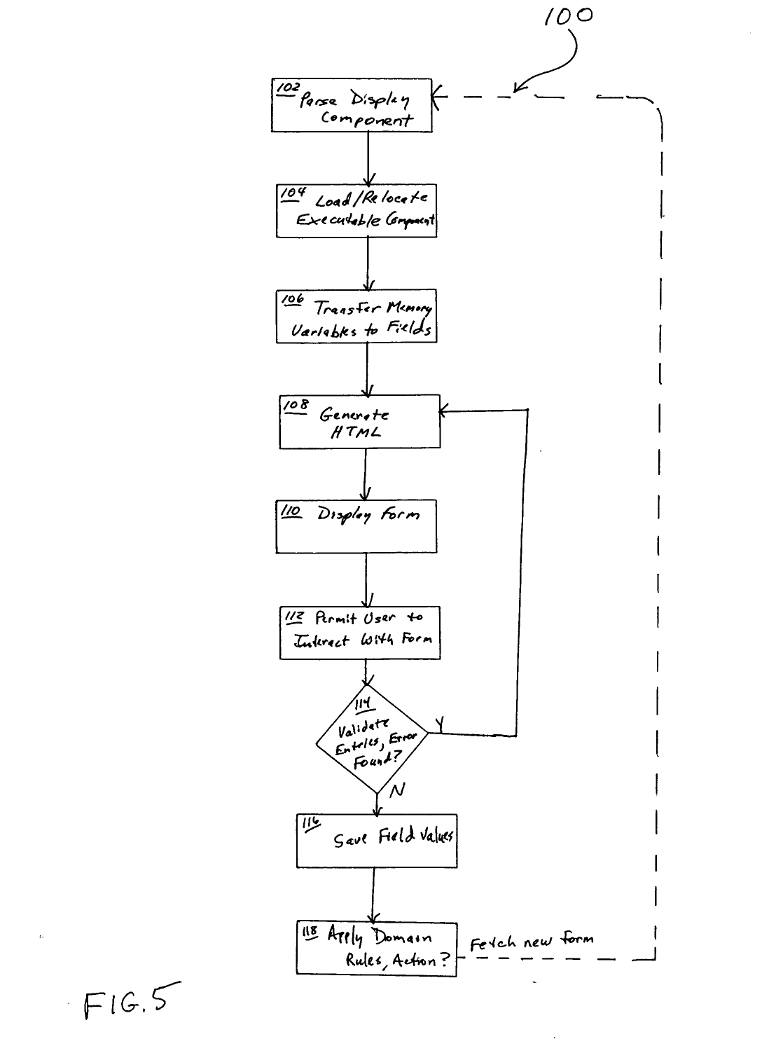

### DETAILED DESCRIPTION OF PREFERRED EMBODIMENTS OF THE INVENTION

The present invention provides a system, method, and computer program product for automating the gathering of complex, structured information from a user of a client computer. The present invention may be used in a variety of settings such as, for example, wherein it is desirable to obtain information from a prospective purchaser of professional services. The present invention permits efficient use of the professional service provider's time and resources, while preventing the disclosure of privileged or confidential information of the purchaser to the professional service provider in situations wherein, for example, conflicts of interest may prevent the service provider from transacting with the purchaser.

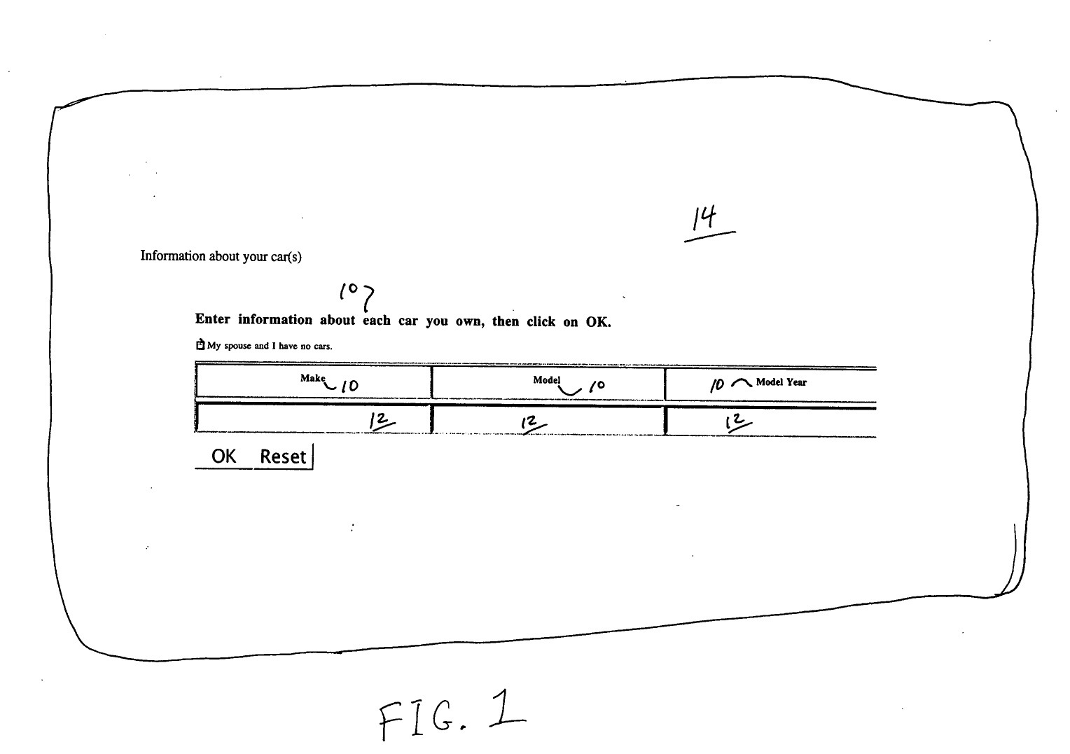

With reference to FIG. 1, a preferred embodiment of the invention utilizes HyperText Markup Language (HTML) with extended functionality to render text 10 and input fields 12 on a display screen 14 with which a user may interact. Information on HTML may be found in T. Bemers-Lee, D. Connoly, “RFC 1866: Hypertext Markup Language—2.0” (November 1995). HTML is a simple data format used to create hypertext documents that are portable from one platform to another, and which has been in use by the World-Wide Web global information initiative since 1990. HTML is an application of ISO Standard 8879; 1986 Information Processing Text and Office Systems; Standard Generalized Markup Language (SGML).

Now that the presentation aspects have been set forth, information will be provided relating to the specific web architecture framework of the present invention. An overview of the hardware and software involved in implementation of the present invention will now be described in detail.

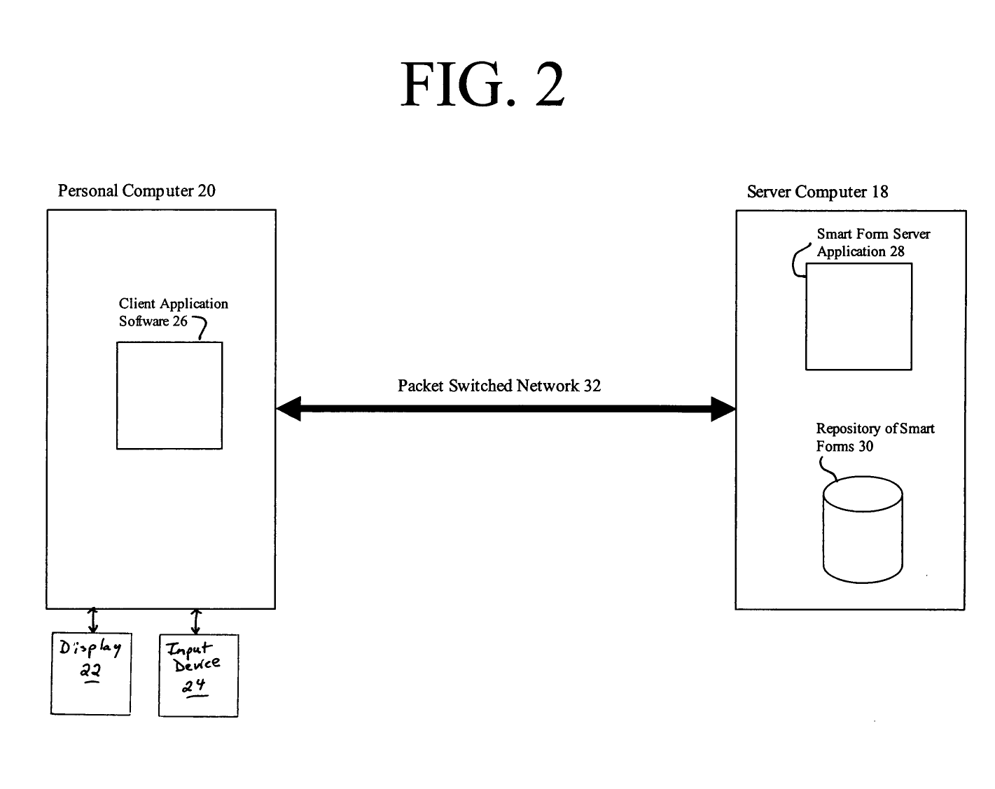

As the terms are used herein, “server” and “client” each refer to any general purposes computer equipped with a processor capable of executing computer software code or logic so as to perform a set of instructions With reference to FIG. 2, a preferred embodiment of a system 16 in accordance with the present invention is preferably practiced in the context of a server computer 18 and a client computer 20. As the terms are used herein, the terms “server” and “client” are not intended to suggest any dependency upon one another for functionality beyond those functions described herein, but rather are intended merely to more easily differentiate the computers, each of which comprises a personal computer such as an IBM compatible personal computer, Apple Macintosh computer or UNIX based workstation. Server computer 18 and client computer 20 typically are configured with hardware (not shown) comprised of a central processing unit, such as a microprocessor, and a number of other units interconnected via a system bus. The computers 18, 20 each preferably include a random access memory, read only memory, an I/O adapter for operatively coupling peripheral devices (such as display device 22 and input device 24) to the computer. Each computer typically has resident thereon an operating system such as the MICROSOFT WINDOWS NT or WINDOWS XP Operating System (OS), the IBM OS/2 operating system, the MAC OS, or UNIX operating system. Those skilled in the art will appreciate that the present invention may also be implemented on platforms and operating systems other than those mentioned.

In another aspect, the present invention provides a computer program product encoded on one or more programmable storage devices, and executable by the client computer 20 and server 18 to perform method steps for automating the gathering of information from a user as described below. The computer program product includes a collection of electronic smart forms each comprised of a display component instructing the client computer 20 how to render text and input fields on the display device 22 and an executable component that includes logic for validating captured user input field data and logic for applying domain knowledge to user response data. The computer program product also includes code for requesting an electronic smart form be sent to the client computer 20, a server application executing on the server 18 for transmitting an electronic form from the collection to the client computer 20 in response to the request, and a client application including code for parsing the display component and executing the executable component of the transmitted electronic form so as to gather response data from a user by rendering on the display device 22 text and input fields associated with the transmitted form, capturing field data input by the user in response to the rendered text and input fields, and validating the input field data, repeating the rendering, capture and validation steps if the validation reveals an user input error, determine whether additional action is necessary at least in part by applying domain based knowledge to the gathered response data, and take said actions if determined necessary, and transmit the user response data from the client computer 20 to another computer such as, for example server 18. The programmable storage device(s) upon which the computer program is encoded may comprise any conventional software media readable by the server 18 and client computer 20, or any disk drive operatively coupled to the microprocessor of the computers. The computers 18, 20 preferably have one or more of the following drives: a hard disk drive for reading from and writing to a hard disk, a magnetic disk drive for reading from or writing to a removable magnetic disk, and an optical disk drive for reading from or writing to a removable optical disk such as a CD ROM. The drives and their associated computer-readable media provide nonvolatile storage of computer readable instructions, data structures, program modules, test results and other data.

Client computer 20 executes a client application software module 26 and server computer 18 executes a smart form server application 28, which is operatively coupled to a repository 30 of electronic smart forms. Server computer 18 and client computer 20 are operatively coupled through a packet switched network 32 such as, for example, the Internet. In operation, a user of the client computer 20 typically downloads the client application 26 and uses it to complete a multi-screen automated interview in as many sessions, and over as much time, as the user desires. Client application 26 facilitates the gathering of information from the user, and will not transmit the gathered interview response data back to the server computer 18 (or any other computer) until client application 26 determines that the interview has been completed. The user may complete the interview over several sessions, in between which the user's response data is stored in encrypted form on client computer 20, where it is accessible only by a user-defined password. Until the user requests transmission of the interview response data, a professional services provider using the server computer 18 (or another computer to which the gathered response data will be sent) is only made aware of the user's IP address and the names of the smart forms being requested by the client application 26. Thus, the professional service provider may, for example, know that a user at a particular IP address is engaged in a bankruptcy interview, however there is no way for any information beyond that fact to be deduced.

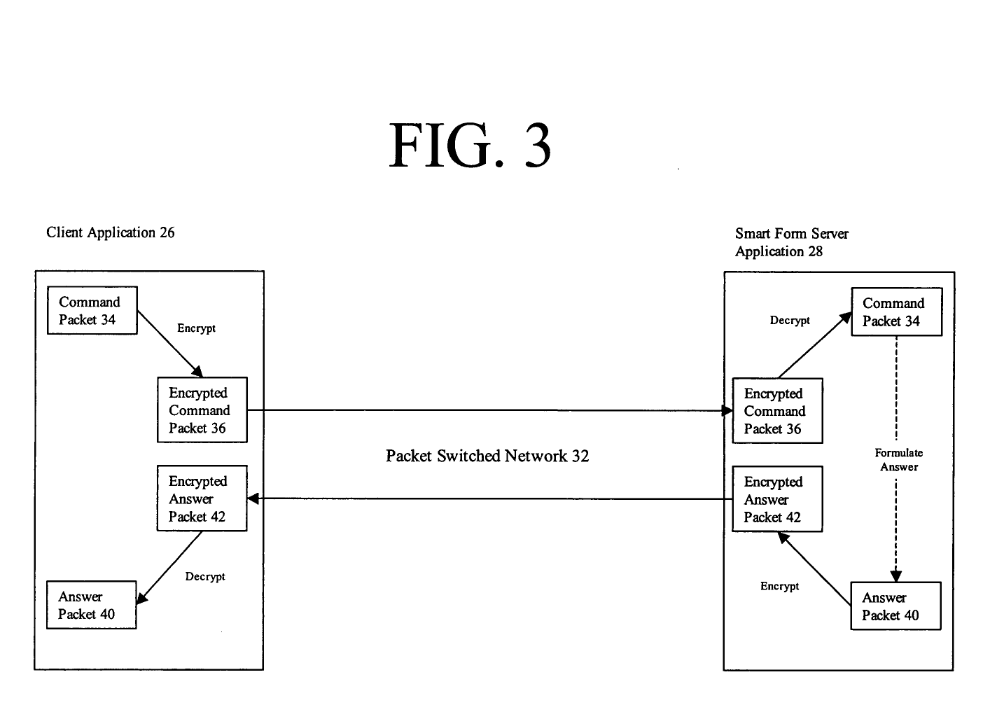

With reference to FIG. 3, the client application 26 and the smart form server application 28 communicate according to a protocol. The client application 26 constructs a command packet 34, encrypts command packet 34 to derive an encrypted command packet 36, and transmits encrypted command packet 36 over the packet-switched network 32 to smart form server application 28. The smart form server application 28 decrypts encrypted command packet 36 to derive command packet 34, performs certain operations, constructs an answer packet 40, encrypts answer packet 42 to derive an encrypted answer packet 44, and transmits encrypted answer packet 44 over the packet-switched network 32 to client application 26. The client application 26 decrypts encrypted answer packet 42 to derive answer packet 40. Preferably, a public domain encryption algorithm such as BLOWFISH is used for the encryption and decryption steps.

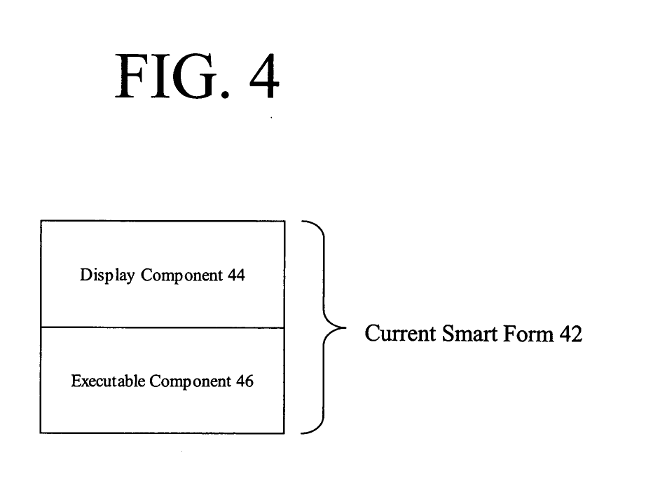

Preferably, each command packet 34 includes a verb and one or more designators. One possible verb commands smart form server application 28 to deliver a smart form, identified by a designator, from the smart form repository 30. As shown in FIG. 4, each smart form 42 is comprised of a display component 44 and an executable component 46. Display component 44 preferably utilizes an extended form of HTML to instruct the client computer 20 how to render the layout and content of text and user-interface elements such as text fields, buttons, check boxes, radio boxes, and drop-down lists of choices and to control conditional behavior of the client application 26, to facilitate localization, and for other purposes, all as more fully described below. Table 1 provides, for exemplary purposes only, a display component 44 that may be used by the client application 26 to render the screen display illustrated in FIG. 1.

TABLE 1
<html>
<head>
<title>Information about your car(s)</title>
<problem id=80000001 text=“A VIN should have 17 letters and digits”>
<listvalue id=80000001 text=“excellent\good\fair\poor”>
</head>
<body>
<font size=“−2” color=#FF0000><errtag></font>
<h2>Enter information about each car you own, then click on OK.</h2>
<p>
<form method=“POST” action=“weblaw://next”>
<p>
<input type=checkbox name=nocars><if G_MARRIED>My spouse and
</if>I have no cars.
<input type=hidden name=more>
<p>
<table border=1>
<tr><th>Make

<th>Model
<th>Model Year
<th>VIN
<th>Mileage
<th>Condition
<th>Lien holder (if any)

<repeat count=10>
<tr><td><font size=“−2” color=#FF0000><errtag name=“make”></font>

<td><font size=“−2” color=#FF0000><errtag name=“model”></font>
<td><font size=“−2” color=#FF0000><errtag name=“year”></font>
<td><font size=“−2” color=#FF0000><errtag name=“vin”></font>
<td><font size=“−2” color=#FF0000><errtag name=“mileage”></font>
<td><font size=“−2” color=#FF0000><errtag name=“condition”></font>
<td><font size=“−2” color=#FF0000><errtag name=“lender”></font>

<tr><td><input type=text name=make size=20>

<td><input type=text name=model size=20>
<td><input type=text name=year size=20>
<td><input type=text name=vin size=20>
<td><input type=text name=mileage size=20>
<td><select size=1 name=condition>

<option value=excellent>Excellent</option>
<option value=good>Good</option>
<option value=fair>Fair</option>
<option value=poor>Poor</option>
</select>

<td><select size=1 name=lender from=“G_SECUREDCREDITORS”></select>

</repeat>
</table>
<p><input type=“submit” value=“ OK ”><input type=“reset”
value=“Reset”></p>
</form>
</body>
</html>

Preferably, as illustrated in Table 2, the executable component 46 is comprised of a binary object code file that results from compiling a single source code file written in the C++ programming language. The executable component 46 embodies in code or logic programming steps for transferring information between memory variables and visible fields on the user's display screen, for validating captured field data input by the user into the visible fields, for applying domain-based knowledge to interpret the user's response data in light of entries on previous forms in order to determine which additional forms should be requested from the smart form server application 28, and presented to the client, and/or to determine which other actions should be taken, as more fully described below.

TABLE 2
#include “stddcls.h”
#include <initguid.h>
#include <RuleObject.h>
#include <errors.h>
#include <resource.h>
// Globally visible variables
#define MAXCARS 10
extern “C” {

//{{AFX_DECLARE_VARIABLES
LONG CarsNoCars;
LONG CarsMore;
char* CarsMake[MAXCARS];
char* CarsModel[MAXCARS];
MDY CarsYear[MAXCARS];
char* CarsVIN[MAXCARS];
LONG CarsMileage[MAXCARS];
LONG CarsCondition[MAXCARS];
LONG CarsLender[MAXCARS];
LONG CarsCount;
LONG CarsFormCount;
//}}AFX_DECLARE_VARIABLES
}

///////////////////////////////////////////////////////////////////////////////
class CCarForm : public CRuleObject

| | |
|---|---|
| { | // class CCarForm |

public:

CCarForm(IWeblaw* iwl) : CRuleObject(iwl) { }
˜CCarForm( );
virtual void STDMETHODCALLTYPE DoDataExchange(BOOL fromform);
virtual void STDMETHODCALLTYPE OnOK( );
//{{AFX_METHODS
DECL_RELOAD(CarsFormCount)
DECL_CONTROL_CHAR(CarsMake)
//}}AFX_METHODS

| | |
|---|---|
| }; | // class CCarForm |

///////////////////////////////////////////////////////////////////////////////
// This routine creates an instance of the rule object and returns an IRuleObject
// interface
extern “C” IRuleObject* _cdecl CreateRuleObject(IWeblaw* iwl)

| { | // CreateRuleObject |
|---|---|
| //{{AFX_INIT_VARIABLES | |
| //}}AFX_INIT_VARIABLES | |
| return new CCarForM(iwl); | |
| } | // CreateRuleObject |

///////////////////////////////////////////////////////////////////////////////

| | |
|---|---|
| // | C R u l e O b j e c t |

///////////////////////////////////////////////////////////////////////////////
CCarForm::˜CCarForm( )

| | |
|---|---|
| { | // CCarForm::˜CCarForm |

//{{AFX_DESTRUCT_VARIABLES
int index;
for (index = 0; index < MAXCARS; ++index)

if (CarsMake[index])

free(CarsMake[index]);

for (index = 0; index < MAXCARS; ++index)

if (CarsModel[index])

free(CarsModel[index]);

for (index = 0; index < MAXCARS; ++index)

if (CarsVIN[index])

free(CarsVIN[index]);

| //}}AFX_DESTRUCT_VARIABLES | |
|---|---|
| } | // CCarForm::˜CCarForm |

///////////////////////////////////////////////////////////////////////////////
void CCarForm::DoDataExchange(BOOLff)

| | |
|---|---|
| { | // CCarForm::DoDataExchange |

//{{AFX_DATA_MAP
RDX_CONTINUE_FV(m_iwl, ff, CarsMore, CarsFormCount, CarsCount, MAXCARS,

MAXCARS, make, more, CarsNoCars);

RDX_KILLBOX(m_iwl, ff, “nocars”, CarsNoCars, CarsFormCount, CarsCount);
RDX_VALUE(m_iwl, ff, “more”, CarsMore);
RDX_ARRAY(m_iwl, ff, “make”, CarsMake, MAXCARS);
RDX_ARRAY_REQUIRED(m_iwl, ff, “model”, CarsModel, MAXCARS);
RDX_ARRAY_REQUIRED(m_iwl, ff, “year”, CarsYear, MAXCARS);
RDX_ARRAY_REQUIRED(m_iwl, ff, “vin”, CarsVIN, MAXCARS);
RDX_ARRAY_REQUIRED(m_iwl, ff, “mileage”, CarsMileage, MAXCARS);
RDX_LIST_ARRAY(m_Iwl, ff, “condition”, 0x80000001, CarsCondition, MAXCARS);
RDX_LIST_ARRAY(m_iwl, ff, “lender”, “G_SECUREDCREDITORS”, CarsLender,

MAXCARS);

RDX_CONTINUE_FF(m_iwl, ff, CarsMore, CarsFormCount, CarsCount, MAXCARS,

MAXCARS, make, more, CarsNoCars);

//}}AFX_DATA_MAP
// Validate the VIN and the model year
if (ff && !CarsNoCars)

| | |
|---|---|
| { | // validate VIN & year |

char fieldname[32];
for (LONG ci = 0; ci < CarsCount; ++ci)

| | |
|---|---|
| { | // for each car |

if (strnull(CarsMake[ci]))

continue;

sprintf(fieldname, “vin%d”, ci + 1);
if (strlen(CarsVIN[ci]) != 17)

m_iwl−>SetFieldProblem(fieldname, 0x80000001); // should have

17 letters & digits

| // A practical form would do additional validation here, such as verifying | |
|---|---|
| // that the model year matches the one encoded in the VIN, that the check | |
| // character in the VIN matches the one calculated from the other 16 | |
| // characters, that the model year is no later than next year, etc. Such | |
| // semantic validation is within the scope of domain knowledge that is hard | |
| // to implement in existing scripting languages. | |
| } | //for each car |

| | |
|---|---|
| } | // validate VIN & year |

| | |
|---|---|
| } | // CCarForm::DoDataExchange |

///////////////////////////////////////////////////////////////////////////////
void CCarForm::OnOK( )

| { | // CCarForm::OnOK |
|---|---|
| //{{AFX_ACTION_MAP | |
| ACTION_ADJUST(CarsMore, CarsFormCount); | |
| //}}AFX_ACTION_MAP | |
| } | //CCarForm::OnOK |

Client application 26 requests an initial smart form from the smart form server application 28 shortly after it commences execution on the client computer 20. From this point forward, client application 26 operates in a method 100 comprising a loop that terminates under circumstances to be presently elaborated. Each iteration of the loop is comprised of at least the following eight steps, labeled 102 through 118, which are performed in relation to a current smart form (CSF). Initially, the initial smart form fetched from the smart form server application 28 is the CSF 42.

Step 102: Parse Display Component

Client application 26 requests and receives each smart form needed from the smart form server application 28 using the protocol described earlier. It then separates the display component 44 associated with the CSF 42 from the executable component 46 and parses it according to the rules of HTML as extended by the present invention. HTML is comprised of a nested hierarchy of “tags” with associated values. The result of the parse is therefore a data structure that reversibly encodes the structure and sequence of the tags described in the display component 44.

The present invention, in one aspect, provides a pseudo-tag named <repeat>. A <repeat> tag includes a count value and is matched by a </repeat> tag. The client application 26 generates uniquely named fields in repetition when it encounters a <repeat> tag in the original display component 44. For example, the following sequence appearing in a display component 44:

<repeat count=10>
<p><input type=text name=whatever></p>
</repeat>

Is equivalent to the following standard HTML:

<p><input type=text name=whatever1></p>
<p><input type=text name=whatever2></p>
...
<p><input type=text name=whatever10></p>

Step 104: Load and Relocate Executable Component

After parsing the display component 44, client application 26 copies the binary executable contents of the executable component 46 into memory and relocates its instructions to refer to program subroutines imbedded in the client application 26 itself and to data variables imbedded in the executable component 4 of the CSF 42 or of previously encountered smart forms.

After loading and relocating the executable component 46, client application 26 calls an initialization subroutine within the executable component 46. An example of a suitable initialization subroutine is shown in Table 2 and is named CreateRuleObject. The initialization subroutine instantiates an object containing virtual function pointers and returns the address of that object. Thereafter, whenever client application 26 wishes to invoke a subroutine within executable component 46, it uses the returned object pointer to invoke the desired virtual function.

Executable component 46 preferably comprises a single object module that has not been combined with other modules by a linkage editor in order to form a free-standing executable module file. Executable component 46 is also preferably restricted in the external subroutines it is allowed to invoke, in order to diminish that harm that might result from inadvertently loading an unauthorized executable component following an attack on the PC by a hacker.

Step 106: Transfer Memory Variables to Fields

In the third step of an iteration, the client application 26 invokes a subroutine, such as the routine named CCarForm::DoDataExchange shown in Table 2, within the executable component 46 to determine which values to display in variable-content fields within the associated display component 44. The executable component 46 carries out its part of this step by calling back into client application 26 with the name and desired value of each field. Client application 26 then records the desired field value in the data structure resulting from the parse (step 102 above.) Preferably, executable component 46 saves an “interface pointer” during its initialization phase as a member variable of the class object instantiated by the initialization routine. The executable component 46 then treats the interface pointer as a pointer to a C++ class containing virtual functions for carrying out many of the operations it needs to perform, including the transfer of memory variables to and from fields on the associated form. In the example presented in Table 2, the interface pointer has the name “m_iwl.”

Step 108: Generate HTML

In the fourth step of an iteration, client application 26 generates an HTML file on disk by traversing the data structure resulting from the parse (step 102 above) as modified by step 106 above and by then writing a temporary disk file. The contents of that HTML file can vary from one iteration to the next based on several factors:

The client is allowed to revisit forms with which the client had previously interacted. When this occurs, client application 26 displays the field values most recently chosen by the client, rather than default values.

Client application 26 maintains a per-form macro dictionary and a global macro dictionary. The display component 44 may specify macro substitution by means of dollar signs. For example, the sequence “$G_CLIENTNAME$” might be used in a particular embodiment of the present invention to denote substitution of the client's name.

The present invention also provides, in another aspect, a conditional pseudo-tag named <if>. An <if> tag instructs client application 26 to conditionally generate or not generate portions of the original display component 44. For example, the original display component 44 might contain the following sequence:
<if G_MARRIED> My spouse and </if> I have no cars.

Based on the answer to a question in a previous form, the executable component 46 of that previous form might have set the global macro G_MARRIED to “TRUE”, in which case the generated HTML would read as follows:
My spouse and I have no cars.
Conversely, that previous form's executable component might have set G_MARRIED to equal an empty string, in which case the generated HTML would read this way instead:
   I have no cars.
The <if> tag can be used with other pseudo tags named <elif> and <else> to generate complex conditional logic within a form.

(4) The present invention also provides, in another aspect, a pseudo-tag named <errtag>. Error tags may be named or unnamed. An unnamed error tag receives a standard localized string value. A named error tag receives a problem string identified by a numeric error number. The unnamed-error string, and the strings for certain common errors (like malformed dates, social security numbers, and the like) are kept within the client application 26 itself. Error messages that are specific to a particular form are encoded in the display component 46 using a <problem> pseudo-tag that contains an error number and the corresponding text.

As an example of a form that might use both <problem> and <errtag> tags, consider a form that asks the client to enter a vehicle identification number. It might contain the following HTML and pseudo-HTML coding:

<html>
<head>
<problem id=80000001

text=“A VIN should have 17 letters and digits”>

</head>
<body>
<font size=“−2” color=#FF0000><errtag></font>
<form method=“POST” action=“weblaw://next”>
<p><font size=“−2” color=#FF0000><errtag name=“vin”></font></br>
VIN:<input type=text name=vin></p>
</form>
</body>
</html>

When the form initially displays, there are no errors, and the error tags are invisible. In this case, client application 26 proceeds as if the display component 44 contained just this information:

<html>
<body>
<form method=“POST” action=“weblaw://next”>
<p>VIN:<input type=text name=vin></p>
</form>
</body>
</html>

Suppose now that the client is permitted to interact with the form (step 112) and incorrectly enters just 16 letters and digits in the VIN field. As discussed below, client application 26 will return to this step 108 to redisplay the form. But a problem number has been assigned to the VIN field. The display will then use the following HTML coding, where the new coding is shown in bold face:

<html>
<font size=“−2” color=#FF0000>There were some problems with the
data you entered. Please correct them and press OK again.</font>
<form method=“POST” action=“weblaw://next”>
<p><font size=“−2” color=#FF0000>A VIN should have 17 letters and
digits</font></br>
VIN:<input type=text name=vin></p>
</form>
</body>
</html>

The display visible to the client in this case will include two error messages using a red font two sizes smaller than standard.

(5) Another aspect of the present invention is a nonstandard property named from for the standard HTML tag named <select>. The value of a from property is the name of a global macro containing a list of choices. For example, a form that is part of an interview sequence for a potential bankruptcy client of an attorney might need to contain a drop-down list containing the names of all secured creditors previously entered on other forms. The following coding in the display component 44 could be used to achieve this goal:
<select name=creditor from=“G_SECUREDCREDITORS ”></select>

Client application 26 would replace the empty space between the <select> and </select> tags with a series of standard <option> tags, one for each creditor named in the G_SECUREDCREDITORS macro.

Step 110: Display Form

In the fifth step of an iteration, client application 26 invokes a software component (HTML Control) to display the HTML file generated in the fourth step in a window on the screen.

Step 112: Permit User to Interact With Form

This sixth step of an iteration is where the user (e.g., a prospective client) actually interacts with the client application 26. The user should read the instructions presented on the screen, which will typically invite the user to provide information or make selections and which will ask the user to select an “OK” button when done. When the user selects the “OK” button, HTML Control software transfers control to the client application 26 along with a textual representation of the then-values of the variable-content fields on the form.

Steps 114-116: Validate Entries and Save Field Values

Client application 26 parses the textual representation of the field values and saves the results in the data structure resulting from the parse of the display component 44 (step 102 above). It then calls the data transfer subroutine, exemplified by the function named CCarForm::DoDataExchange (appearing in Table 2), to perform syntactic and semantic validation of those results (step 114.) To simplify the coding of the data transfer subroutine, client application 26 exports a number of subroutines that accept the textual value of a field and a target memory variable; if the textual value is correctly formed according to the rules for the appropriate data type, such subroutine converts the textual value to the correct internal form and stores the result in the target memory variable (step 116.) Otherwise, such subroutine makes a record that the field has an error.

The data transfer subroutine may also perform semantic validation of field entries. For example, a form may call for the client to enter a vehicle identification number, and the data transfer subroutine may verify that the value entered contains 17 letters and digits and meets the other constraints of a valid vehicle identification number. Also for example, a form may call for the client to enter his or her birthday, and the data transfer subroutine can verify that the client's age, as inferred from the entered birth date, lies within reasonable commonsense bounds.

If the data transfer subroutine discovers an error in a field entry, it causes the client application 26 to repeat the steps of the loop beginning with step 108. Otherwise, it causes the client application 26 to advance to the next step. For example, in Table 2, the coding checks to see whether the vehicle identification number entered by the client is exactly 17 characters long; if not, that coding causes the form to be redisplayed with an error message.

Step 118: Apply Domain Rules

In the last step of an iteration, client application 26 calls a subroutine within the executable component 46 to reason about, or interpret, the results of the client's interaction with the CSF based upon domain knowledge and preferably the results of interactions with previous smart forms.

Domain knowledge is preferably imbedded in the executable component 46 of the smart form 42 in the form of programming logic reflective of knowledge of a particular professional services domain. For example, in the context of an interview of a potential bankruptcy client, a smart form used for gathering information about a debt would include a field to permit the client to indicate whether any other person (a “co-debtor” in bankruptcy parlence) is also liable for the debt. A person having knowledge of the relevant domain would infer several things from an affirmative answer to that question: (a) it is necessary to obtain the name and address of the co-debtor, (b) it will be necessary for the co-debtor to be listed in the creditor matrix filed with the Bankruptcy Court, (c) the co-debtor is a person with an interest adverse to the client, and so on. Each of these deductions can preferably be expressed by altering the flow of forms presented to the client, recording values in external variables that will be accessed by the executable components of other smart forms, and by other means familiar to computer programmers.

One result of the executable component 46 reasoning may be that additional smart forms need to be fetched from the server computer 18 (indicated by the dotted line back up to step 102) or that smart forms already part of the interview script should be removed from the script. Preferably, the executable component 46 invokes code such as the following to direct client application 26 to add or remove a smart form:

if (CreditorCodebtor[ci])
m_iwl−>AddWtg(“CodebtorInfo”);
else
m_iwl−>DelWtg(“CodebtorInfo”);

Another result of the executable component 46 reasoning may be a determination that certain facts should immediately be brought to the attention of the professional to whom the interview results will eventually be submitted. In the context of a legal consultation, for example, one result of reasoning about the inputs provided by the client may be the names of parties having adverse interests to those of the client. An attorney deciding whether to accept a consultation needs to review those names to determine whether a conflict of interest exists precluding representation. The executable component 46 preferably records such names by invoking code such as the following:
m_iwl->SetConflictString(CONFLICT_ADVERSE_ID, CreditorName[ci]);

The results of all calls to SetConflictString from within the collection of smart forms completed by the client is preferably uploaded to the server computer in a single file (a Conflict File) that contains nothing but the codes (such as CONFLICT_ADVERSE_ID) and strings (such as CreditorName[ci]) supplied as arguments in such calls. An attorney processing the results of a client interview about a legal problem would review the information in the Conflict File in order to detect possible conflicts of interest. If the results of that review indicated the presence of a conflict, the attorney might fulfill his ethical obligations to the new client and to all past clients without seeing any privileged information about the new client.

It is to be understood that the above-described arrangements are only illustrative of the application of the principles of the present invention. In particular, the present invention is intended to comprehend a method for gathering complex structured information using a computer. Numerous other modifications and alternative arrangements from what is disclosed here may be devised by those skilled in the art without departing from the spirit and scope of the present invention, and the appended claims are intended to cover such modifications and arrangements.

It is claimed:

1. A computer-implemented method of gathering information from a user of a client computer, and a display device and input device operatively coupled to the client computer, comprising the steps of:
providing a collection of electronic forms, each including a display component instructing the client processor how to render text and input fields on the display device and an executable component for execution on the client computer that includes logic for validating captured user input field data and logic for applying domain knowledge to user response data;
requesting an electronic form be sent to the client computer;
transmitting an electronic form from the collection to the client computer in response to the request;
gathering response data from a user by rendering on the display text and input fields associated with the transmitted form, capturing field data input by the user in response to the rendered text and input fields, and validating the input field data, repeating this step if the validation reveals an user input error;
determining whether additional action is necessary at least in part by applying domain based knowledge to the gathered response data, and taking said actions if determined necessary; and
transmitting the user response data from the client computer to another computer.

2. The method of claim 1, wherein the additional action comprises requesting an additional electronic form from the collection and returning to the form transmitting step if another electronic form is required.

3. The method of claim 1, wherein the determining step is further based at least in part on previously gathered response data.

4. The method of claim 1, wherein the user response data is transmitted over a network.

5. The method of claim 1, wherein the additional action comprises providing a selected portion of the response data to the another computer.

6. The method of claim 1, wherein the rendered text and input fields are conditionally generated.

7. The method of claim 1, wherein the rendered text and input fields are re-rendered with or without modification if an input error is revealed by the validation step.

8. The method of claim 7, further comprising generating an error message with the re-rendered text and input fields.

9. The method of claim 1, further comprising the step of encrypting the user response data prior to transmission from the client computer.

10. The method of claim 1, wherein the display component is comprised of HTML instructions.

11. The method of claim 10, wherein the display component further comprises at least one HTML-compatible tag providing expanded functionality selected from the group consisting of tags for repeating text or fields, tags for conditionally displaying text or fields, tags for conditionally displaying error messages, and tags for populating a list of choices from a list not part of the HTML source code.

12. The method of claim 1, further comprising the step of separating the response data into at least one unprivileged or non-confidential part and at least one privileged or confidential part prior to prior to transmission from the client computer.

13. The method of claim 1, wherein the gathered response data relates to professional services.

14. The method of claim 1, wherein the response data is acquired over as many user sessions as the user desires, with interim data being stored in encrypted form between user sessions.

15. System for automating the gathering of information from a user, comprising:
a server to which a repository is operatively coupled;
a client computer operatively coupled to the server;
a collection of electronic forms stored on the repository, each electronic form including a display component instructing the client processor how to render text and input fields on a display operatively coupled to the client computer, and an executable component for execution on the client computer that includes logic for validating captured user input field data and logic for applying domain knowledge to user response data;
a form server application executing on the server and including logic for transmitting one or more forms from the collection in response to form requests; and
a client application executing on the client computer including logic for requesting forms from the form server application, and logic for parsing the display component and logic for executing the executable component of the transmitted one or more forms so as to:
gather response data from a user by rendering on the display text and input fields associated with the transmitted one or more forms, capturing field data input by the user in response to the rendered text and input fields, and validating the input field data, repeating this step if the validation reveals an user input error;
determine whether additional action is necessary at least in part by applying domain based knowledge to the gathered response data, and taking said actions if determined necessary; and
transmit the user response data from the client computer to another computer.

16. The system of claim 15, wherein the executable component is comprised of a binary object file containing external references to locations in the client application and in the executable components of other forms from the collection.

17. The system of claim 15, wherein the additional action comprises requesting an additional electronic form from the collection and returning to the form transmitting step if another electronic form is required.

18. The system of claim 15, wherein the determining step is further based at least in part on previously gathered response data.

19. The system of claim 15, wherein the user response data is transmitted over a network.

20. The system of claim 15, wherein the additional action comprises providing a selected portion of the response data to the another computer.

21. The system of claim 15, wherein the client application further comprises logic for conditionally generating the rendered text and input fields.

22. The system of claim 15, wherein the client application further comprises logic for re-rendering the text and input fields with or without modification if an input error is revealed by the validation step.

23. The system of claim 22, wherein the client application further comprises logic for generating an error message with the re-rendered text and input fields.

24. The system of claim 15, wherein the client application further comprises logic for encrypting the user response data prior to transmission from the client computer.

25. The system of claim 15, wherein the display component is comprised of HTML instructions.

26. The system of claim 25, wherein the display component further comprises at least one HTML-compatible tag providing expanded functionality selected from the group consisting of tags for repeating text or fields, tags for conditionally displaying text or fields, tags for conditionally displaying error messages, and tags for populating a list of choices from a list not part of the HTML source code.

27. The system of claim 15, wherein the client application further comprises logic for separating the response data into at least one unprivileged or non-confidential part and at least one privileged or confidential part prior to prior to transmission from the client computer.

28. The system of claim 15, wherein the gathered response data relates to professional services.

29. The system of claim 15, wherein the client application further comprises logic for acquiring the response data over as many user sessions as the user desires, with interim data being stored in encrypted form between user sessions.

30. A computer program product encoded on one or more programmable storage devices, for use in a system including a client computer operatively coupled to a server, and a display device and an input device operatively coupled to the client computer, the computer program product executable by the client computer and server to perform instructions for automating the gathering of information from a user, comprising:
a collection of electronic forms, each including a display component instructing the client processor how to render text and input fields on the display device and an executable component for execution on the client computer that includes logic for validating captured user input field data and logic for applying domain knowledge to user response data;
code for requesting an electronic form be sent to the client computer;
a server application executing on the server for transmitting an electronic form from the collection to the client computer in response to the request;
a client application including code for parsing the display component and executing the executable component of the transmitted electronic form so as to:
gather response data from a user by rendering on the display text and input fields associated with the transmitted form, capturing field data input by the user in response to the rendered text and input fields, and validating the input field data, repeating this step if the validation reveals an user input error;
determine whether additional action is necessary at least in part by applying domain based knowledge to the gathered response data, and take said actions if determined necessary; and
transmit the user response data from the client computer to another computer.

31. The computer program product of claim 30, wherein the additional action comprises requesting an additional electronic form from the collection and returning to the form transmitting step if another electronic form is required.

32. The computer program product of claim 30, wherein the determining step is further based at least in part on previously gathered response data.

33. The computer program product of claim 30, wherein the additional action comprises providing a selected portion of the response data to the another computer.

34. The computer program product of claim 30, wherein the client application further comprises code for conditionally generating the rendered text and input fields.

35. The computer program product of claim 30, wherein the client application further comprises code for re-rendering the text and input fields with or without modification if an input error is revealed by the validation step.

36. The computer program product of claim 35, wherein the client application further comprises code for generating an error message with the re-rendered text and input fields.

37. The computer program product of claim 30, wherein the client application further comprises code for encrypting the user response data prior to transmission from the client computer.

38. The computer program product of claim 30, wherein the display component is comprised of HTML code.

39. The computer program product of claim 38, wherein the display component further comprises at least one HTML-compatible tag providing expanded functionality selected from the group consisting of tags for repeating text or fields, tags for conditionally displaying text or fields, tags for conditionally displaying error messages, and tags for populating a list of choices from a list not part of the HTML source code.

40. The computer program product of claim 30, wherein the client application further comprises code for separating the response data into at least one unprivileged or non-confidential part and at least one privileged or confidential part prior to prior to transmission from the client computer.

41. The computer program product of claim 30, wherein the gathered response data relates to professional services.

42. The computer program product of claim 30, wherein the client application further comprises code for acquiring the response data over as many user sessions as the user desires, with interim data being stored in encrypted form between user sessions.
